(19) United States
(12) Patent Application Publication
(10) Pub. No.: US 2015/0129281 A1
(43) Pub. Date: May 14, 2015

(54) WIRE HOLDER

(71) Applicant: YAZAKI CORPORATION, Tokyo (JP)

(72) Inventors: Kiyotaka HANAOKA, Kakegawa-shi (JP); Takanori KANAMORI, Kakegawa-shi (JP); Takuomi WADA, Kakegawa-shi (JP)

(73) Assignee: YAZAKI CORPORATION, Tokyo (JP)

(21) Appl. No.: 14/538,155

(22) Filed: Nov. 11, 2014

(30) Foreign Application Priority Data
Nov. 11, 2013 (JP) 2013-233476

(51) Int. Cl. H01B 17/30

(52) U.S. Cl. CPC H01B 17/308
USPC 174/152 R

(57) ABSTRACT

A wire holder which is configured to hold an electric wire that is to be passed through a housing, includes: a resin-made holder body which is inserted into the housing, and in which a wire passing hole through which the electric wire is to be passed is formed; and annular rubber packings which are attached to an outer surface of the holder body and an inner surface of the wire passing hole, respectively, and which are formed by insert molding in which the holder body is set in a molding die.

### CROSS-REFERENCE TO RELATED APPLICATION(S)

This application is based upon and claims the benefit of priority from prior Japanese patent application No. 2013-233476, filed on Nov. 11, 2013, the entire contents of which are incorporated herein by reference.

### BACKGROUND

1. Technical Field

The present invention relates to a wire holder through which electric wires are to be passed.

2. Background Art

As a related-art waterproof connector, for example, there is a structure in which a synthetic resin-made wire holder through which electric wires are to be passed is attached to a tubular housing. As shown in FIG. 6, a housing 101 includes a plurality of spaces 103 through which electric wires 102 are to be passed. In each of the spaces 103, a front holder 104 which is formed into a step-like shape, and which functions as a wire holder is accommodated, and an annular rubber packing 105 is housed in the rear (right side) of the holder. To the backs of the rubber packings 105, a rear holder 106 which functions as a wire holder common thereto is attached, so that the rubber packings 105 are held between the front holder 104 and the rear holder 106. The configuration where the rubber packings 105 are interposed between the two wire holders enables the rubber packings 105 to be attached to and detached from the housing 101.

For example, the electric wires 102 are introduced in a state where they are passed through the front holder 104, the rubber packings 105, and the rear holder 106. The rubber packings 105 press the outer circumferential surfaces of the electric wires 102, and the inner surface of the housing 101, thereby keeping the gaps between the electric wires 102 and the housing 101 watertight.

In the structure shown in FIG. 6, however, the front holder 104, the rubber packings 105, and the rear holder 106 in a state where they have not yet been introduced into the housing 101 are supported merely by the electric wires 102. Therefore, the work of accommodating them into the spaces 103 of the housing 101 is hardly conducted. In order to push out the rubber packings 105 from the housing 101, moreover, the rear holder 106 is necessary. Therefore, the number of components is large, and the structure is complicated.

On the other hand, another structure shown in FIG. 7 is disclosed where, in a waterproof connector 113 including a tubular housing 111, and a wire holder 112 which has a recessed shape, and which is attached to the housing 111, a plurality of tubular rubber packings 115 are integrally formed in the bottom surface of the wire holder 112, and wire passing holes 116 are formed in the rubber packings 115, respectively (see JP-A-2001-15205).

In the housing 111, a plurality of terminal accommodating chambers 118 are formed by a partition wall 117, and terminals 120 which are connected to the tip ends of electric wires 119 passed through the rubber packings 115 are accommodated in the terminal accommodating chambers 118, respectively when the wire holder 112 is attached to the housing 111. The rubber packings 115 keep watertight the gaps with respect to the electric wires 119 passed through the rubber packings 115, and those with respect to the inner surfaces 121 of the housing 111. When the rubber packings 115 are integrated with the wire holder 112 as described above, attachment and detachment of the rubber packings 115 are enabled by the simple structure.

However, the rubber packings 115 in JP-A-2001-15205 are merely supported in a cantilever manner by the wire holder 112. When the wire holder 112 is attached to the housing 111 in a tilted state, therefore, there is a possibility that the rubber packings 115 are pressed against the housing 111 to be damaged.

### SUMMARY

The present invention may provide a wire holder in which the structure is simplified and robber packings are prevented from being damaged.

The wire holder, which is configured to hold an electric wire that is to be passed through a housing, may comprise: a resin-made holder body which is inserted into the housing, and in which a wire passing hole through which the electric wire is to be passed is formed; and annular rubber packings which are attached to an outer surface of the holder body and an inner surface of the wire passing hole, respectively, and which are formed by insert molding in which the holder body is set in a molding die.

In at least one of the outer surface of the holder body and the inner surface of the wire passing hole to which the rubber packings are attached, a concave in which a corresponding one of the rubber packings is accommodated protrudingly may be formed.

In at least one of the outer surface of the holder body and the inner surface of the wire passing hole to which the rubber packings are attached, a convex which is embedded in a corresponding one of the rubber packings may be formed.

### BRIEF DESCRIPTION OF THE DRAWINGS

FIG. 1 is an overall perspective view showing a state where wire harnesses are assembled to a housing.

FIG. 2 is an external perspective view of a rear holder to which the invention is applied.

FIG. 3 is a perspective view showing the appearance obtained before rubber packings are attached to the rear holder.

FIG. 4 is across sectional view of the rear holder through which electric wires are passed.

FIG. 5 is a cross sectional view showing a state where the rear holder is attached to the housing.

FIG. 6 is a cross sectional view of a related-art waterproof connector.

FIG. 7 is a cross sectional view of another related-art waterproof connector.

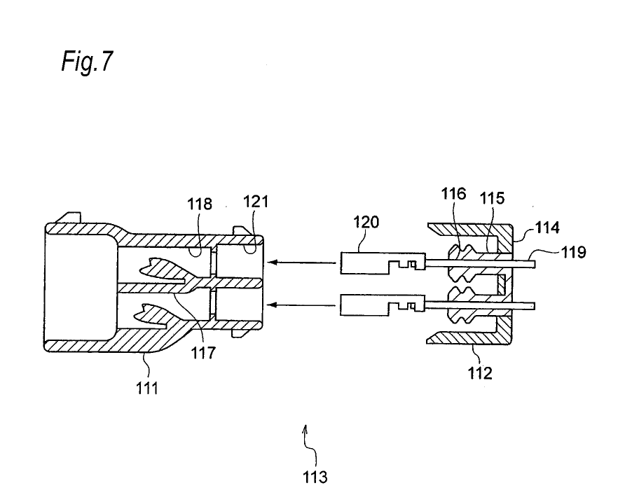

### DETAILED DESCRIPTION OF EXEMPLARY EMBODIMENTS

Hereinafter, an embodiment of a rear holder of the invention will be described with reference to the drawings.

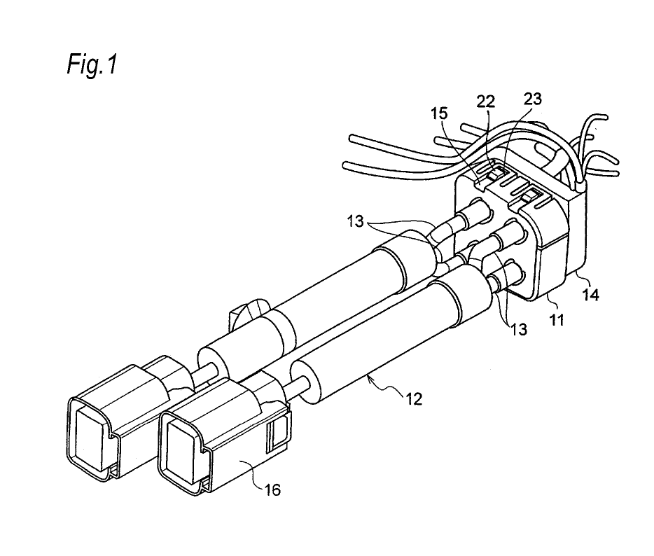

As shown in FIG. 1, a wire holder 11 of the embodiment is used, for example, in connection of electric wires 13 of wire harnesses 12 to an electric apparatus mounted on a vehicle such as an electric vehicle or a hybrid vehicle. A housing 15 which is projected in a rectangular tubular shape is disposed on a wall 14 of a case in which the electric apparatus is accommodated. The wire holder 11 through which the electric wires 13 of the wire harnesses 12 are passed is attached to the housing 15, whereby the tip end sides of the electric wires 13 led out from the wire holder 11 are allowed to be guided from the housing 15 into the case to be connected to the electric apparatus. The wall 14 in FIG. 1 shows a part of the case.

Each of the wire harnesses 12 in the embodiment is formed by bundling two electric wires 13 as one set. FIG. 1 shows a state where (four) electric wires 13 of two wire harnesses 12 are introduced into the case through the wire holder 11. One ends of the electric wires 13 are connected to the electric apparatus in the case, and on the other hand the other ends of the electric wires 13 are connected to a connector housing 16 which is to be connected to the counter connector. Terminal fittings (not shown) are accommodated in the connector housing 16. The other ends of the electric wires 13 are connected to the terminal fittings.

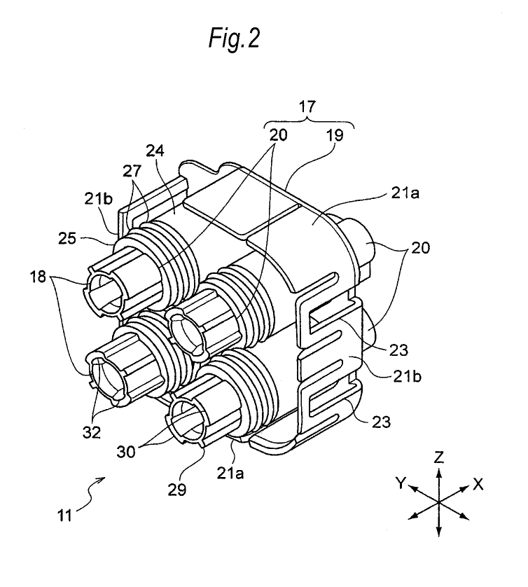

FIG. 2 shows the appearance of the wire holder 11 as viewed from the front side. In FIG. 2, the X direction indicates the front-back direction of the wire holder 11. Here, the front side indicates the direction (the right side of FIG. 1) along which the wire holder 11 is attached to the housing 15, and the rear side indicates the direction (the left side of FIG. 1) along which the wire holder 11 is detached from the housing 15. The Y direction indicates the width direction of the wire holder 11, and the Z direction indicates the height direction of the wire holder 11. Here, the upper side in the Z direction indicates of the upper side of the wire holder 11, and the lower side in the Z direction indicates of the lower side of the wire holder 11. In the following description, these directions are applied also to the other figures.

The wire holder 11 is formed by molding a synthetic resin. The wire holder 11 includes the holder body 17 which is attached to the housing 15, and a plurality of wire passing holes 18 through which the electric wires 13 are passed. The holder body 17 has a rectangular bottom plate 19, and four cylindrical portions 20 which extend while passing in the front-back direction through the bottom plate 19. The wire passing holes 18 are formed in the inner sides of the cylindrical portions 20, respectively. The cylindrical portions 20 are placed so that their axes are substantially parallel to each other. In the periphery of the cylindrical portions 20, a wall 21 is formed by forward raising the four edges of the bottom plate 19 so as to surround the cylindrical portions 20.

The wall 21 includes two sets of wall portions 21a, 21b which are opposed to each other. Each of the paired wall portions 21a is formed into a rectangular side plate, and each of the paired wall portions 21b has two engaging claws 23 with which engaging projections 22 (FIG. 1) of the housing 15 are to be engaged. The wall portions 21a, 21b may be formed in a rectangular tubular shape so as to be continuous with each other, or separate from each other.

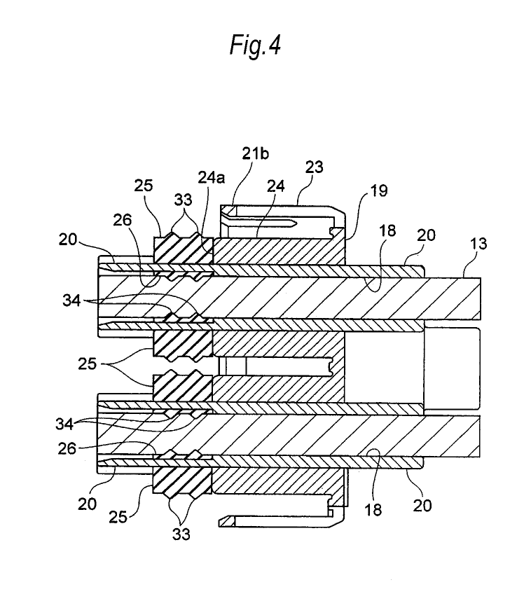

Each of the cylindrical portions 20 includes a large-diameter portion 24 which is forward projected from the bottom plate 19. To the cylindrical portion 20 which is projected from the front end face of the large-diameter portion 24, an annular rubber packing 25 is attached along the outer circumferential surface, and an annular rubber packing 26 (FIG. 4) is attached along the inner circumferential surface.

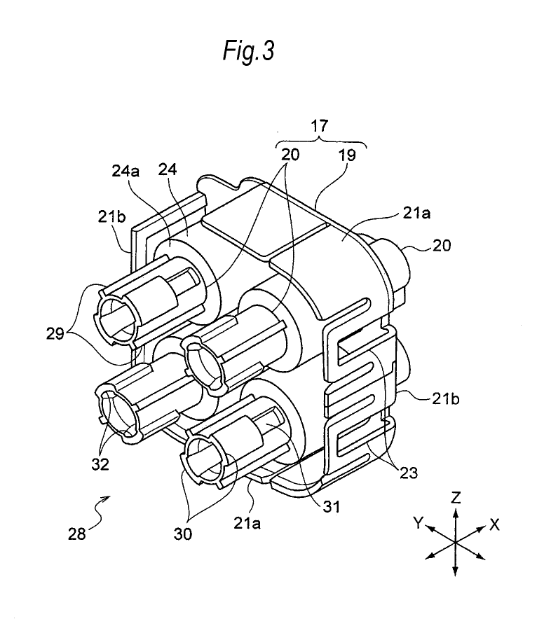

Next, characteristic configurations of the embodiment will be described with reference to FIGS. 2 to 4. In the wire holder 11 of the embodiment, by insert molding, the rubber packings 25 are formed along the outer circumferential surfaces of the cylindrical portions 20, and the rubber packings 26 are formed along the inner circumferential surfaces of the cylindrical portions 20. In the embodiment, as shown in FIG. 3, a molded article 28 of the wire holder 11 which is previously obtained by molding a synthetic resin is set in the cavity of a molding die, and then the cavity is filled with a rubber material by insert molding, whereby the rubber packings 25 and the rubber packings 26 are simultaneously molded to be formed integrally with the molded article 28.

The insert molding of this type is a related-art technique. With respect to the rubber packings 25, for example, the rubber material is filled along the gaps between the outer circumferential surfaces of the cylindrical portions 20 of the molded article 28 which is set in the cavity, and the wall surface of the cavity, whereby the annular rubber packings 25 can be formed. With respect to the rubber packings 26, for example, pins (not shown) having a step-like shape are inserted from the rear side to the front ends into the cylindrical portions 20 of the molded article 28 which is set in the cavity, and the rubber material is filled along the gaps between the side surfaces of the pins that are reduced in diameter, and the inner circumferential surfaces of the cylindrical portions 20, whereby the annular rubber packings 26 can be formed.

As shown in FIG. 3, a pair of convexes 29, and a pair of projections 30 are disposed on the outer circumferential surface of each of the cylindrical portions 20 of the molded article 28. The pair of convexes 29 are disposed in a form of an axial ridge in a range from the front end of the cylindrical portion 20 to the front end face 24a of the large-diameter portion 24, so as to be projected in the opposite directions. The pair of projections 30 are disposed by radially projecting a predetermined circumferential range of the cylindrical portion 20, so as to axially extend by a predetermined length, and to be projected in the opposite directions. Furthermore, concaves 31 which are rectangular in a plan view are formed in the outer circumferential surface of the cylindrical portion 20, at positions which are axially adjacent to the projections 30, i.e., between the projections 30 and the front end face 24a of the large-diameter portion 24. On the other hand, in the inner circumferential surface of the cylindrical portion 20, a pair of grooves 32 which axially extend are formed on the backs of the projections 30, and ridges which are not shown are formed on the backs of the concaves 31.

As shown in FIG. 4, the rubber packings 25 and the rubber packings 26 are fixed by insert molding to the cylindrical portions 20 of the thus formed molded article 28. In FIG. 4, in order to avoid complexity of the drawing, illustrations of the convexes 29, the projections 30, the concaves 31, the grooves 32, and the like are omitted. Each of the rubber packings 25 is annularly formed along the outer circumferential surface of the corresponding cylindrical portion 20 so as to overlap with the convexes 29 and the concaves 31. Therefore, the convexes 29 are embedded in the inner circumferential surface of the rubber packing 25, whereby recesses are formed along the convexes 29, and the rubber material is caused to enter and fill the insides of the concaves 31, so that projections are formed along the concaves 31. According to the configuration, the motion, particularly rotational motion of the rubber packings 25 is restricted. Since the rubber packings 25 are formed between the projections 30 and the front end faces 24a of the large-diameter portions 24, motion is axially restricted.

On the other hand, each of the rubber packings 26 is annularly formed along the inner circumferential surface of the corresponding cylindrical portion 20 so as to overlap with the ridges (the back side of the concave 31) which are not shown. Therefore, the ridges are embedded in the rubber packing 26, and hence recesses are formed along the ridges in the outer circumferential surface of the cylindrical portion 20. Consequently, the motion, particularly rotational motion of the rubber packings 25 is restricted.

On the outer circumferential surface of each of the cylindrical portions 20, a plurality (two) of lips 33 are protrudingly formed over the whole circumference while forming an axial gap. On the inner circumferential surface of each of rubber packings 26, a plurality (two) of lips 34 are protrudingly formed over the whole circumference while forming an axial gap.

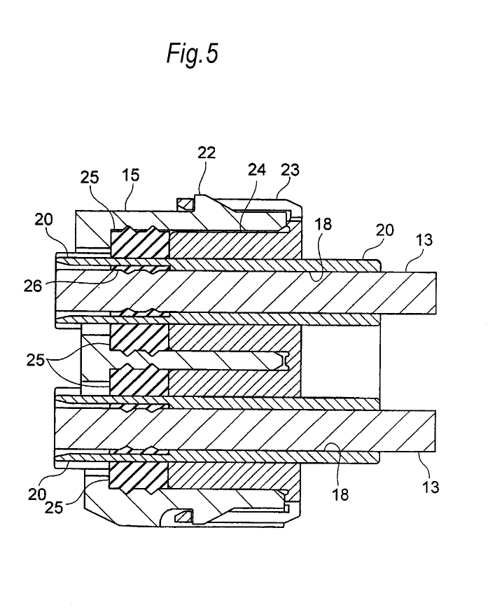

In the wire holder 11 in which the rubber packings 25, 26 are formed as described above, the electric wires 13 of the wire harnesses 12 are passed through the cylindrical portions 20, respectively. As shown in FIG. 5, the wire holder 11 through which the electric wires 13 are passed is attached so as to cover the hosing 15. Therefore, the engaging projections 22 of the housing 15 are engaged with the engaging claws 23 of the wire holder 11, respectively, and the wire holder 11 is fixed to the housing 15.

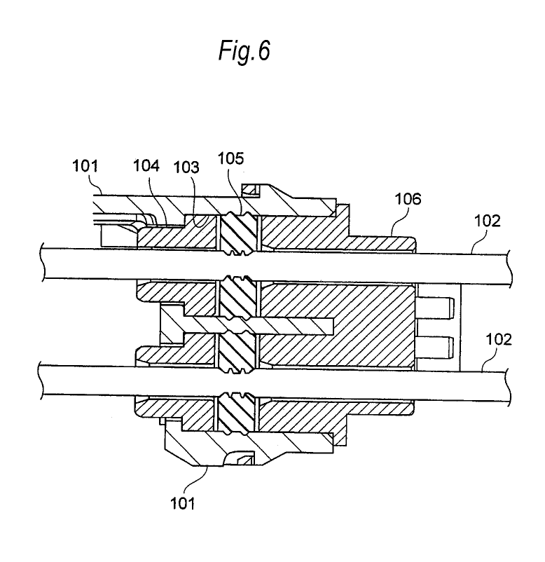

According to the embodiment, as described above, the rubber packings 25, 26 are formed by insert molding on the outer and inner surfaces of the cylindrical portions 20 of the molded article 28, and hence the molded article 28 and the rubber packings 25, 26 can be integrated with each other. Therefore, the number of components is reduced, and the structure is simplified. Consequently, the assembling man-hours are reduced, and assembly errors can be suppressed from occurring. Since the number of components is reduced, furthermore, the number of molding dies to be used can be reduced, and hence the production cost can be largely lowered. According to the embodiment, referring to FIG. 6, the front holder 104 is not necessary, and the rubber packings 105 and the rear holder 106 are integrated with each other. Therefore, the work of mounting respective components into the spaces 103 of the housing 101 is not required, and the work of passing the electric wires 13 through the housing 15 is facilitated. Since the rubber packings 25, 26 are fixed along the cylindrical portions 20 of the molded article 28, moreover, it is possible to prevent the rubber packings 25, 26 from being deformed when the cylindrical portions 20 are attached to the housing 15. Therefore, the rubber packings 25, 26 can be prevented from being damaged.

In the embodiment, the rubber packings 25 are formed so as to overlap with the convexes 29 and concaves 31 of the cylindrical portions 20. Therefore, recesses and projections which extend along them are formed on the surfaces of the rubber packings 25. Since the rubber packings 26 are formed so as to overlap with the ridges of the cylindrical portions 20, moreover, recesses which extend along the ridges are formed on the surfaces of the rubber packings 25. Therefore, the force of fixing the rubber packings 25, 26 to the cylindrical portions 20 can be enhanced, and hence it is possible to further prevent the rubber packings 25, 26 from being peeled off and positionally displaced. As a result, it is possible to further prevent the rubber packings 25, 26 from being damaged.

The rubber packings 25, 26 which are formed by insert molding as in the embodiment have a configuration which are apparently different from that of rubber packings that are attached lately and merely to the molded article 28. Namely, the insert molding of the rubber packings 25, 26 enables the rubber packings to be strongly contacted (fixed) with the surfaces of the cylindrical portions 20. In the latter rubber packings, by contrast, gaps are formed between the outer circumferential surfaces of the cylindrical portions 20 and the packings. In the rubber packings 25, 26 in the embodiment, the concaves and the convexes are formed along with the shapes of the inner and outer circumferential surfaces of the cylindrical portions 20. In the latter rubber packings, such a shape does not exist. In the embodiment, for example, a case may sometimes occur where, on the inner circumferential surface of each of the cylindrical portions 20, the rubber material which has flown from the front end toward the corresponding packing 26 is solidified to form a remaining thick portion. This phenomenon is specific to insert molding. When observing the appearance or section of the wire holder 11, therefore, it is possible to easily discriminate whether the wire holder is formed by insert molding or not.

Although the embodiment of the invention has been described in detail with reference to the drawings, the above-described embodiment is merely a simple example of the invention., and the invention is not limited only to the configuration of the embodiment. It is a matter of course that any design change within the scope of the gist of the invention included in the invention.

In the embodiment, the example in which the convexes 29 and the projections 30 are formed on the outer circumferential surfaces of the cylindrical portions 20, and the ridges are formed on the inner circumferential surfaces has been described. However, the invention is not limited to this. A convex and concave shape of another form may be formed. The packings 25, 26 are fixed to the outer and inner circumferential surfaces of the cylindrical portions 20. Even when the convex and concave shape is not formed, therefore, a sufficient fixing force can be obtained.

In the embodiment, the case has been exemplarily described where the housing 15 projected from the wall 14 of the case in which an electric apparatus is accommodated is used as the object to which the wire holder 11 is to be attached. The attachment object is not limited to this. For example, the invention can be applied also to a case where two wire harnesses 12 are connected to each other. Namely, the wire holder 11 of the embodiment can be used while being attached to the connector housing 16 or the like of the wire harness 12 which functions as a connection counterpart.

According to an aspect of the invention, there is provided a wire holder which is configured to hold an electric wire that is to be passed through a housing, the wire holder comprising: a resin-made holder body which is inserted into the housing, and in which a wire passing hole through which the electric wire is to be passed is formed; and annular rubber packings which are attached to an outer surface of the holder body and an inner surface of the wire passing hole, respectively, and which are formed by insert molding in which the holder body is set in a molding die.

When the rubber packings are insert molded and fixed to the holder body as described above, the rubber packings and the holder body can be integrated with each other. Therefore, the number of components is reduced, and the structure is simplified. Consequently, the assembling man-hours are reduced, and assembly errors can be suppressed from occurring. Since the number of components is reduced, furthermore, the number of molding dies to be used can be reduced, and hence the production cost can be lowered. Since the rubber packings are fixed to the holder body having a predetermined strength, moreover, the rubber packings can be prevented from being deformed when the holder body is attached to the housing. Therefore, it is possible to prevent the rubber packings from being damaged.

In this case, in at least one of the outer surface of the holder body and the inner surface of the wire passing hole to which the rubber packings are attached, a concave in which a corresponding one of the rubber packings is accommodated protrudingly may be formed. According to the configuration, the force of fixing the rubber packings to the holder body can be enhanced, and therefore the rubber packings can be prevented from being peeled off and positionally displaced when the holder body is attached to the housing. As a result, it is possible to further prevent the rubber packings from being damaged.

In place of or in addition to the concave, in at least one of the outer surface of the holder body and the inner surface of the wire passing hole to which the rubber packings are attached, a convex which is embedded in a corresponding one of the rubber packings may be formed. Also in the configuration, the force of fixing the rubber packings to the holder body can be enhanced, and therefore the rubber packings can be prevented from being peeled off and positionally displaced. Therefore, it is possible to further prevent the rubber packings from being damaged.

According to an aspect of the invention, the structure of the wire holder can be simplified, and the rubber packings can be prevented from being damaged.

What is claimed is:

1. A wire holder which is configured to hold an electric wire that is to be passed through a housing, the wire holder comprising:
a resin-made holder body which is inserted into the housing, and in which a wire passing hole through which the electric wire is to be passed is formed; and
annular rubber packings which are attached to an outer surface of the holder body and an inner surface of the wire passing hole, respectively, and which are formed by insert molding in which the holder body is set in a molding die.

2. The wire holder according to claim 1, wherein,
in at least one of the outer surface of the holder body and the inner surface of the wire passing hole to which the rubber packings are attached, a concave in which a corresponding one of the rubber packings is accommodated protrudingly is formed.

3. The wire holder according to claim 2, wherein,
in at least one of the outer surface of the holder body and the inner surface of the wire passing hole to which the rubber packings are attached, a convex which is embedded in a corresponding one of the rubber packings is formed.

4. The wire holder according to claim 1, wherein,
in at least one of the outer surface of the holder body and the inner surface of the wire passing hole to which the rubber packings are attached, a convex which is embedded in a corresponding one of the rubber packings is formed.
